(19) United States
(12) Patent Application Publication
(10) Pub. No.: US 2018/0310040 A1
(43) Pub. Date: Oct. 25, 2018

(54) METHOD AND APPARATUS FOR VIEW DEPENDENT DELIVERY OF TILE-BASED VIDEO CONTENT

(71) Applicant: Nokia Technologies Oy, Espoo (FI)

(72) Inventors: Prasad Balasubramanian, Fremont, CA (US); Maneli Noorkami, Mountain View, CA (US); Basavaraja Vandrotti, San Jose, CA (US)

(21) Appl. No.: 15/493,843

(22) Filed: Apr. 21, 2017

(51) Int. Cl. H04N 21/2343; H04N 21/2187; H04N 21/81

(52) U.S. Cl. CPC H04N 21/23439; H04N 21/816; H04N 21/234363; H04N 21/2187

(57) ABSTRACT

A method, apparatus and computer program product provide for view dependent delivery of tile-based video content. In the context of a method, coordinates and span of each of a plurality of tiles of video content generated by an encoder are determined. The method also includes creating a media presentation description including segment information and supplemental fields including information regarding the coordinates and span of each of a plurality of tiles of video content. The method further includes providing for view dependent delivery by associating the media presentation description with file segments to be delivered to a player. A corresponding apparatus and computer program product are also provided.

### TECHNOLOGICAL FIELD

An example embodiment of the present disclosure relates generally to view dependent delivery of video content and, more particularly, to the provision of view dependent delivery in reliance upon a media presentation description that includes supplemental fields including information relating to the coordinates and span of each of a plurality of tiles of video content.

### BACKGROUND

An increasing amount of video content is captured and delivered for a variety of different applications. For example, video content may be delivered via live streaming, such as for virtual reality applications or other types of applications. The video content that is captured and delivered may be expansive and may provide a 360° panoramic view. As such, a user who has only a limited field of view at any one instant to change their viewing direction, such as by rotating their head when the user is wearing a head-mounted device or by providing other forms of input, such as a swiping gesture in an instance in which the user is viewing video content on a display, such as a provided by a mobile or tablet device, while continuing to view the video content.

In conjunction with virtual reality content, the entire 360° of video content may be streamed to a player. However, the user of a virtual reality application has a limited field of view so that at any point in time the user views only a portion of the entire 360° of video content. If the entire 360° of video content is streamed at a high resolution and a high bit rate so as to have a high quality, the equipment employed by the user will be required to support a very high bandwidth to consume the virtual reality content. Such a high bandwidth is impractical in many instances. Additionally, video content players are generally limited by the capability of its hardware to decode such high resolution content. Many current players support the decoding of 4K resolutions, thus requiring that the 360° video stream is encoded as a single 4K stream, thereby also limiting the resolution per degree that may be supported.

In order to limit the bandwidth required to deliver video content, multiple versions of the video content having different levels of resolution may be created by the content server. Depending upon the viewing direction of the user, the video content that is located in the viewing direction is delivered at a high resolution, while all other video content is delivered at a lower resolution. As the user alters their viewing direction, the video content that is delivered at the high resolution is correspondingly altered to correspond to the updated viewing direction, while all other video content is delivered at a lower resolution. As such, only one stream of video content needs to be delivered at the high resolution, thereby limiting the bandwidth required for delivery of the video content.

Alternatively, the video content may be broken into overlapping or non-overlapping tiles. Each tile is encoded separately at a relatively high resolution and is broken into segments that are delivered by a content delivery network. Simultaneous with the generation and encoding of each tile, a low resolution base layer of the video content is generated and delivered over the content delivery network. In this type of system, a compatible player requests delivery of the relevant tiles based on the user's field of view for presentation in high resolution. The player also receives the lower-resolution base layer, which is displayed outside of the field of view of the user. The player requires a media presentation description in order to discover the tiles and to identify the tiles to be fetched based upon the user's field of view. However, live production encoders and cloud based transcoding solutions for live broadcasts do not provide for the ability to discover the tiles and to identify the tiles to be fetched. As such, view dependent delivery is generally not supported for live streaming, be it for virtual reality or other applications.

### BRIEF SUMMARY

A method, apparatus and computer program product are provided in accordance with an example embodiment in order to provide for view dependent delivery of tile-based video content. The method, apparatus and computer program product of an example embodiment create a media presentation description that includes supplemental information including the coordinates and span of each of a plurality of tiles of the video content in order to facilitate view dependent delivery of, for example, 360° video content, be it for live streaming or video on demand or other offline scenarios. By providing for view dependent delivery in accordance with an example embodiment, the bandwidth required by a user, e.g., a player, in order to view, e.g., 360° video content, may be reduced, thereby making the video content more widely available. Additionally, the view dependent delivery in accordance with an example embodiment may also allow users to view higher resolution video content, such as without an increase in the bandwidth that is required for downloading.

In an example embodiment, a method is provided that includes determining coordinates and span of each of a plurality of tiles of video content generated by an encoder. The method also includes creating a media presentation description including segment information and supplemental fields including information regarding the coordinates and span of each of a plurality of tiles of video content. The method further includes providing for view dependent delivery by associating the media presentation description with file segments to be delivered to a player.

The method of an example embodiment also includes receiving an encoder-generated media presentation description. In this embodiment, creating the media presentation description includes combining the segment information from the encoder-generated media presentation description with information regarding the coordinates and span of each of a plurality of tiles of video content. In another example embodiment, the method also includes receiving an encoder-generated media presentation description and repeatedly refreshing the media presentation description so as to include information from the encoder-generated media presentation description. In this example embodiment, the encoder-generated media presentation description may include information regarding a publish time and an availability start time and the method may repeatedly refresh the media presentation description by including information regarding the publish time and the availability start time. For example, the media presentation description may be repeatedly refreshed in conjunction with live streaming of the video content. Alternatively, the media presentation description may be created a single time for a video on demand application.

In another example embodiment, an apparatus is provided that includes at least one processor and at least one memory including computer program code with the at least one memory, coupled to the at least one processor, and the computer program code configured to, when executed by a processor, cause the apparatus to determine coordinates and span of each of a plurality of tiles of video content generated by an encoder. The at least one memory and the computer program code are also configured to, when executed by the processor, cause the apparatus to create a media presentation description including segment information and supplemental fields including information regarding the coordinates and span of each of a plurality of tiles of video content. The at least one memory and the computer program code are further configured to, when executed by the processor, cause the apparatus to provide for view dependent delivery by associating the media presentation description with file segments to be delivered to a player.

The at least one memory and the computer program code may be further configured to receive encoder-generated media presentation description, and to cause the apparatus to create the media presentation description by combining the segment information from the encoder-generated media presentation description with information regarding the coordinates and span of each of a plurality of tiles of video content. The at least one memory and the computer program code may be further configured to, when executed by the processor, cause the apparatus of an example embodiment to receive an encoder-generated media presentation description and to repeatedly refresh the media presentation description so as to include information from the encoder-generated media presentation description. In this example embodiment, the encoder-generated media presentation description may include information regarding a publish time and an availability start time, and the at least one memory and the computer program code may be configured to, when executed by the processor, cause the apparatus to repeatedly refresh the media presentation description by including information regarding the publish time and the availability start time. For example, the media presentation description may be repeatedly refreshed in conjunction with live streaming of the video content. Alternatively, the media presentation description may be created a single time for a video on demand application. The apparatus of one example embodiment is embodied by the encoder, while the apparatus of another example embodiment is embodied by a computing device in communication with but discrete from the encoder.

In a further example embodiment, a computer program product includes a non-transitory computer readable storage medium comprising instructions that, when executed, are configured to determine coordinates and span of each of a plurality of tiles of video content generated by an encoder. The instructions are also configured to create a media presentation description including segment information and supplemental fields including information regarding the coordinates and span of each of a plurality of tiles of video content. The instructions are further configured to provide for view dependent delivery by associating the media presentation description with file segments to be delivered to a player.

The instructions of an example embodiment are further configured to receive an encoder-generated media presentation description. In this example embodiment, the instructions configured to create the media presentation description comprise instructions configured to combine the segment information from the encoder-generated media presentation description with information regarding the coordinates and span of each of a plurality of tiles of video content. In another example embodiment, the instructions, when executed, are further configured to receive an encoder-generated media presentation description and to repeatedly refresh the media presentation description so as to include information from the encoder-generated media presentation description. In an example embodiment in which the encoder-generated media presentation description includes information regarding a publish time and an availability start time, the instructions configured to repeatedly refresh the media presentation description comprise instructions configured to include information regarding the publish time and the availability start time. In an example embodiment, the media presentation description is repeatedly refreshed in conjunction with live streaming of the video content. Alternatively, the media presentation description may be created a single time for a video on demand application.

In yet another example embodiment, an apparatus is provided that includes means for determining coordinates and span of each of a plurality of tiles of video content generated by an encoder. The apparatus also includes means for creating a media presentation description including segment information and supplemental fields including information regarding the coordinates and span of each of a plurality of tiles of video content. The apparatus further includes means for providing for view dependent delivery by associating the media presentation description with file segments to be delivered to a player.

### BRIEF DESCRIPTION OF THE DRAWINGS

Having thus described embodiments of the present disclosure in general terms, reference will now be made to the accompanying drawings, which are not necessarily drawn to scale, and wherein:

FIG. 1 is a block diagram of an apparatus that may be specifically configured in accordance with an example embodiment of the present disclosure;

FIG. 2 is a flowchart illustrating operations performed, such as by the apparatus of FIG. 1, in accordance with an example embodiment of the present disclosure;

FIG. 3 is a flowchart illustrating operations performed, such as by the apparatus of FIG. 1, in accordance with another example embodiment of the present disclosure;

FIG. 4 is a diagram of a system that provides for view dependent delivery in accordance with an example embodiment of the present disclosure; and

FIG. 5 is a diagram of a system that provides for view dependent delivery in accordance with another example embodiment of the present disclosure.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, field programmable gate array, and/or other computing device.

As defined herein, a “computer-readable storage medium,” which refers to a physical storage medium (e.g., volatile or non-volatile memory device), may be differentiated from a “computer-readable transmission medium,” which refers to an electromagnetic signal.

A method, apparatus and computer program product are provided in accordance with an example embodiment in order to provide for view dependent delivery of tile-based video content. In this regard, the method, apparatus and computer program product generate and provide a media presentation description that includes supplemental fields including information relating to the coordinates and span of each of a plurality of tiles of video content. Thus, a player, such as a video content display system, a decoder or the like, may readily identify the tiles that correspond to a user's field of view such that the tiles that correspond to the user's field of view may be downloaded and displayed with a relatively high resolution, while the remainder of the video content is provided via a lower resolution base layer, thereby reducing the bandwidth required for delivery of the video content while still providing a high quality video experience for the user.

The method, apparatus and computer program product of an example embodiment may be employed in conjunction with live production encoders and/or cloud based transcoding solutions for live broadcast that do not otherwise support the generation of a media presentation description to signal the location and span of the tiles. Consequently, the method, apparatus and computer program product may support view dependent delivery for both video on demand applications as well as live streaming of video content, such as for virtual reality applications or other types of applications.

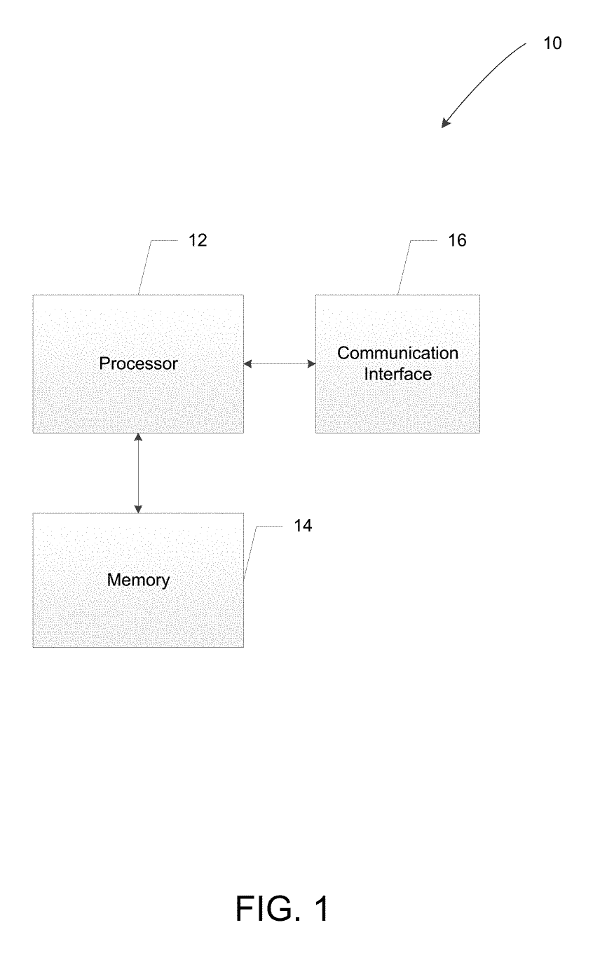

An apparatus configured to provide for view dependent delivery in accordance with an example embodiment may be embodied by a variety of different computing devices, such as a computer workstation, a server, a distributed computing network, an encoder or the like. Regardless of the manner in which the apparatus is embodied, the apparatus 10 of an example embodiment may be configured as shown in FIG. 1 so as to include, be associated with or otherwise be in communication with a processor 12 and a memory 14 and optionally with a communication interface 16.

In some embodiments, the processor 12 (and/or co-processors or any other processing circuitry assisting or otherwise associated with the processor) may be in communication with the memory device 14 via a bus for passing information among components of the apparatus 10. The memory device may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

The apparatus 10 may, in some embodiments, be embodied in various computing devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 12 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 12 may be configured to execute instructions stored in the memory device 14 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of instructions, the instructions may specifically configure the processor to perform the algorithms and/or operations described herein when the instructions are executed. However, in some cases, the processor may be a processor of a specific device (e.g., an image processing system) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

In embodiments that include an optional communication interface 16, the communication interface may be any means such as a device or circuitry embodied in either hardware or a combination of hardware and software that is configured to receive and/or transmit data from/to a network and/or any other device or module in communication with the apparatus 10, such as an encoder, a database or other storage device, such as cloud storage, a player or other client, etc. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface 24 may alternatively or also support wired communication. As such, for example, the communication interface may include a communication modem and/or other hardware/software for supporting communication via cable, digital subscriber line (DSL), universal serial bus (USB) or other mechanisms.

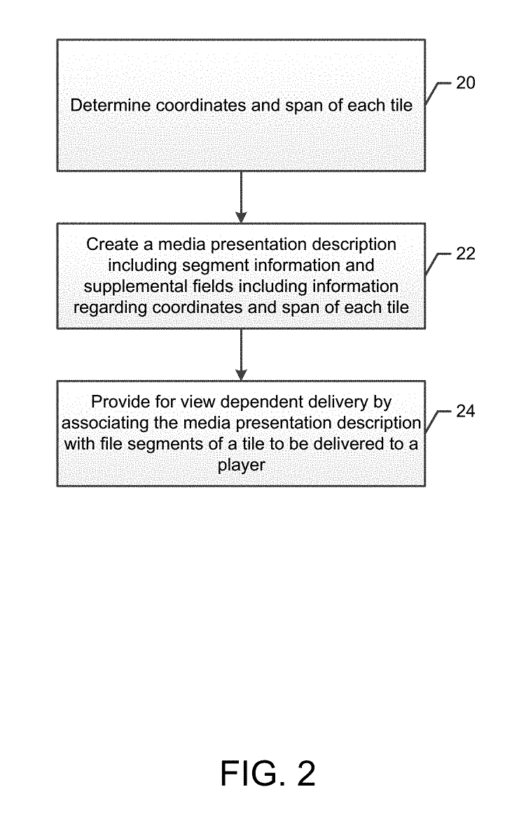

The operations performed, such as by the apparatus 10 of FIG. 1, in accordance with an example embodiment will now be described by way of example, but not of limitation, with respect to the flowchart of FIG. 2. In this regard, the apparatus of an example embodiment includes means, such as the processor 12 or the like, for determining the coordinates and span of each of a plurality of tiles of video content generated by an encoder. In this regard, the apparatus, such as the processor, the communication interface 16 of the like, may receive the plurality of tiles of video content directly from the encoder, such as in conjunction with live streaming applications. Alternatively, the plurality of tiles of video content may have been stored, such as by memory 14 or by another database, and may be subsequently accessed by the apparatus, such as in conjunction with a video on demand application.

The video content generated by the encoder may be any of a variety of different types of video content. As described herein by way of example, but not of limitation, the video content may provide a panoramic view, such as an entire 360° panoramic view, and may be utilized for various applications including, but not limited to, virtual reality applications. In addition, the size and location of the tiles into which the video content is divided may vary based upon the encoder, the application for which the video content is provided, historical behavior of the user or other factors. The encoder may crop the video content into a plurality of tiles and may run multiple encoding sessions at the same time in order to encode each of the different tiles at a relatively high resolution, while also scaling and encoding the entire video content as a lower resolution base layer. While the tiles of video content each include only a portion of the entire video content, the base layer generally encompasses the entirety of the video content, albeit at a lower resolution. The tiles of video content as well as the base layer may be encoded, by the encoder, as separate video streams. Based upon the user's field of view, such as defined by the viewing direction of the user as determined by the player, the tile(s) of video content that are associated with, that is, coextensive with, the field of view may be delivered along with the base layer of the video content. As such, the player may decode and present the video content for the user such that the user views the high resolution video content within their field of view, while lower resolution video content is provided outside of the user's field of view. As such, the user will enjoy a high quality video experience, while the bandwidth necessary for delivery of the video content is conserved.

In accordance with an example embodiment, the apparatus 10, such as the processor 12, determines the coordinates and span of each of the plurality of tiles of video content separately encoded at a high resolution by the encoder. For a respective tile, the coordinates define the location of the tile. The coordinates may be defined in various manners including a center point of the tile, corner points of the tile or the like. The coordinates may be defined in terms of an angle relative to a predefined viewing point, in spherical coordinates, in terms of a pixel as defined by an (x, y) location, or the like. In addition, the span that is determined may be defined in various manners so as to define the size of the respective tile. While each tile may have the same span, that is, the same size, the tiles of some embodiments may have different spans. A span may be defined, both horizontally and vertically, in various manners including in terms of an angular range, in terms of a number of pixels or the like.

As shown in block 22 of FIG. 2, the apparatus 10 also includes means, such as the processor 12 or the like, for creating a media presentation description including segment information and supplemental fields including information regarding the coordinates and span of each of a plurality of tiles of video content. In this regard, the video content is generally divided into relatively small file segments that are delivered to a client, such as the player, a database or the like, upon request. For example, the video content including the file segments may be provided in conjunction with a dynamic adaptive streaming protocol, such as Moving Picture Experts Group (MPEG) Dynamic Adaptive Streaming over HTTP (DASH) protocol in which content is delivered as file segment through Hypertext Transport Protocol (HTTP) requests from the player. The encoder generally provides each tile as an independent stream along with an encoder-generated media presentation description. However, the encoder-generated media presentation description does not provide information relating to the location, that is, the coordinates, and the size, that is, the span, of the respective tiles. However, the encoder-generated media presentation description does provide segment information. Although a variety of segment information may be provided, examples of segment information include the type of segment, e.g., dynamic or static, the publish time, the start time, the profile, the codec, the frame rate, etc. As such, the apparatus, such as the processor, of an example embodiment creates the media presentation description including the segment information provided by the encoder-generated media presentation description along with supplemental fields that include information regarding the coordinates and span of the respective tile that have been determined.

As shown in block 24 of FIG. 2, the apparatus 10 also includes means, such as the processor 12, communication interface 16 or the like, for providing for view dependent delivery by associating the media presentation description with file segments to be delivered to the player. In this regard, the media presentation descriptions for the tiles encoded by the encoder may be provided to the player. For a user having a certain field of view, the tile(s) that are associated with the field of view, such as by filling the field of view, are identified, such as by the player, based upon the coordinates and span of the tile(s) as defined by the respective media presentation descriptions. The tile(s) are then requested, such as via an HTTP request. The file segments that comprise the tile(s) associated with the field of view are then provided at a high resolution. Additionally, the file segments that comprise the base layer are also provided to the player. Thus, the player reviews the media presentation description associated with the file segments for each tile that is delivered and, as such, may appropriately locate and size each tile at the relatively high resolution with the remainder of the video content being derived from the base layer at a lower resolution.

The user may therefore enjoy relatively high resolution video content within the field of view, while still permitting the bandwidth required for delivery of the video content to be conserved since the tiles that lie outside the field of view need not be downloaded (with the video content outside of the field of view instead being provided by the lower resolution base layer). By creating a more fulsome media presentation description that not only includes the segment information provided by the encoder for each tile, but also information regarding the coordinates and span of each tile, video content may be delivered following encoding by live production encoders or cloud based transcoding solutions for live broadcast that do not otherwise provide information regarding the location and size of the tiles of high resolution video content. Consequently, the apparatus 10 of an example embodiment may support live streaming of video content with the high resolution tiles being appropriately located and sized relative to the user's field of view. Additionally, on alternatively, the apparatus may be configured to support video on demand applications, such as in instances in which the video has been stored prior to delivery.

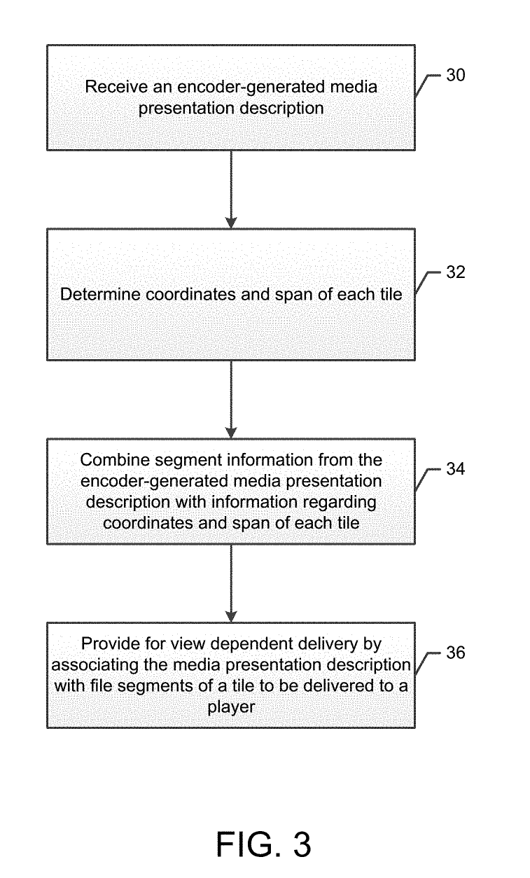

Referring now to FIG. 3, a flow chart illustrating the operations performed, such as by the apparatus 10 of an example embodiment, are provided a way of explanation of one particular example embodiment. In this embodiment, the apparatus includes means, such as the processor 12, communication interface 16 or the like, for receiving an encoder-generated media presentation description. See block 30 of FIG. 3. As described above, the encoder-generated media presentation description may include segment information for the plurality of file segments that comprise the respective tiles. After having determined the coordinates and span of each of a plurality of tiles of video content generated by an encoder as described above in conjunction with block 20 of FIG. 2 and as shown by block 32 of FIG. 3, the apparatus also includes means, such as the processor or the like, for combining the segment information from the encoder-generated media presentation description with information regarding the coordinates and span of each of a plurality of tiles of video content. See block 34 of FIG. 3.

As described above in conjunction with block 24 of FIG. 2 and as shown by block 36 of FIG. 3, the apparatus 10 also includes means, such as the processor 12, communication interface 16 or the like, for providing for view dependent delivery by associating the media presentation description with file segments of the tiles to be delivered to the player. In this regard, based upon the coordinates and span of the various tiles as defined by the respective media presentation descriptions, the player may request the specific tiles that fall within the user's field of view for downloading along with the lower resolution base layer. Conversely, the tiles that lie outside of the user's field of view are not downloaded to the player, thereby conserving bandwidth.

In conjunction with a video on demand application, the apparatus 10, such as the processor 12, need only create the media presentation description a single time. However, in conjunction with live streaming of video content, the apparatus also includes means, such as the processor or the like, for repeatedly refreshing the media presentation description so as to include information, such as updated information, from the encoder-generated media presentation description. In this regard, the encoder-generated media presentation description may include information regarding a publish time and availability start time. The. Using these times player can find the order of the segments to be played. The publish time and the availability start time indicate the timing information associated with the video content with the start time indicating the start time of the streaming content and the publish time indicating the segment publish time. The start time and the publish time may be utilized by the player to identify the appropriate segment of video content at which to commence playback of the video content and/or the order of the segments to be played. The publish time and availability start time may vary over the course of time for the video content. Thus, the apparatus, such as the processor, of this example embodiment may be configured to refresh the media presentation description by re-creating the media presentation description so as to include, not only the segment information and the coordinates and span of a respective tile, but also the publish time and availability start time provided by the most recent encoder-generated media presentation description.

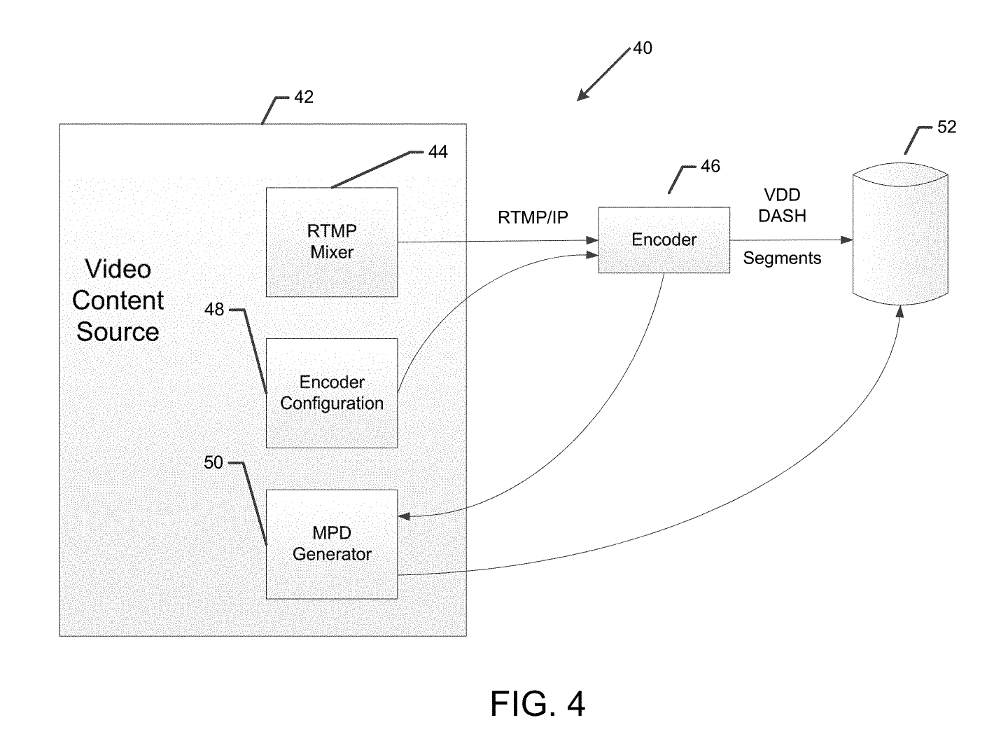

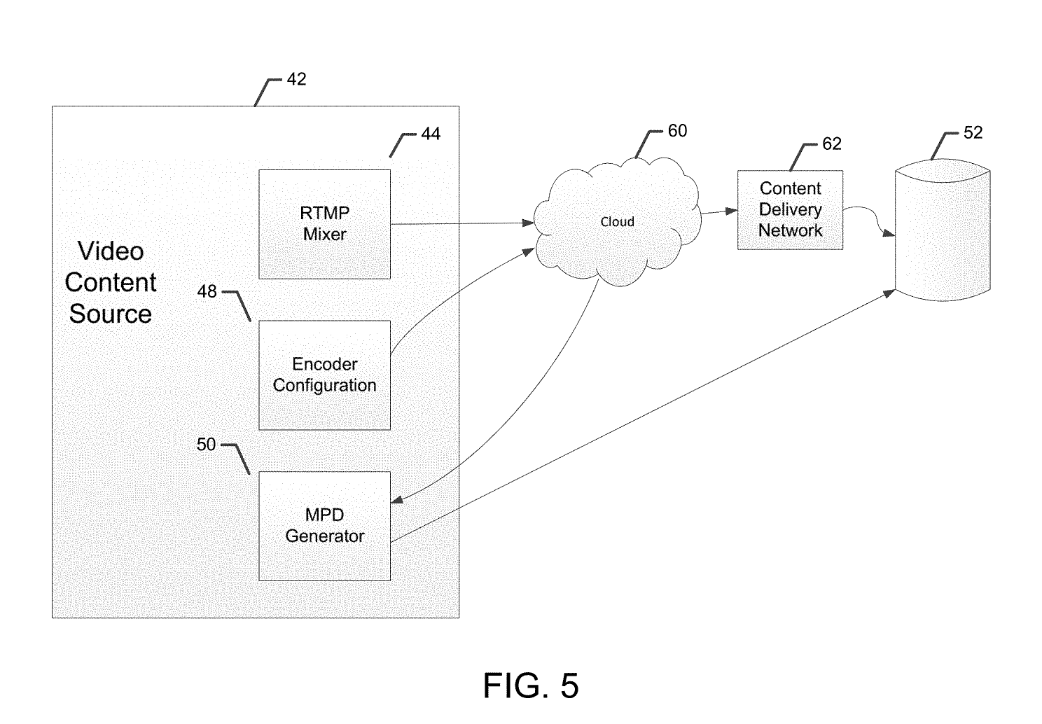

The apparatus 10 may be utilized in a variety of different types of systems, two of which are depicted in FIGS. 4 and 5 and described herein by way of example, but not of limitation. In this regard, FIG. 4 depicts a system 40 for view dependent delivery with an encoder 46 located on the premises of the video content source 42. In this regard, the video content source may provide a stream of video content. The video content may be provided by the video content source to the encoder in accordance with a variety of different protocols, such as via Real-Time Messaging Protocol/Internet Protocol (RTMP/IP) as provided by an RTMP mixer 44 of the video content source in the illustrated embodiment. The video content source of the illustrated embodiment also includes an encoder configuration 48 that is provided to the encoder. The encoder configuration may be embodied by a memory device that is configured to store and provide various information to the encoder for configuration purposes including, for example, the type of encoder, e.g., an H.264 encoder or a High Efficiency Video Coding (HEVC) encoder, a group of pictures (GOP) size, the bit rate, etc. The encoder then encodes the video content, such as by cropping the video content into a plurality of tiles that are each encoded at a relatively high resolution and provided as separate streams along with a stream that provides a lower resolution base layer of the video content. Each stream may be comprised of a plurality of file segments. The file segments may be provided in accordance with a variety of different protocols including, for example, as view dependent delivery (VDD) DASH segments. The file segments may be provided to a player in conjunction with live streaming applications or to a database 52 for storage, such as in conjunction with video on demand applications.

In accordance with an example embodiment, the video content source 42 may also include or be in association with an apparatus 10 designated as the media presentation description (MPD) Generator 50 in FIG. 4 and configured in accordance with an example embodiment of the present disclosure in order to create a media presentation description that includes supplemental fields including information relating to the coordinates and span of each of a plurality of tiles of video content. The media presentation description includes not only the supplemental field regarding the coordinates and span of each of a plurality of tiles of a video content, but also segment information. This segment information may be provided by a encoder-generated media presentation description with the resulting media presentation description including both the segment information and the supplemental fields including information regarding the coordinates and span of each of a plurality of tiles of video content provided, for example, to a player or to a database 52. The media presentation descriptions may then be utilized to identify the tile(s) that are coextensive with the user's field of view and that should be downloaded along with the lower resolution base layer in order to support the display of high resolution video content within the field of view and lower resolution content outside of the field of view.

Alternatively, the apparatus 10 may be employed in conjunction with a view dependent delivery system that relies upon cloud base encoding and transcoding services as shown in FIG. 5. In this example embodiment, the video content and information regarding the encoder configuration may be provided by the video content source 42 to the cloud 60 for generation of the file segments corresponding to each of a plurality of tiles into which the video content has been cropped as well as the file segments corresponding to the lower resolution base layer of the video content. The file segments may be delivered via a content delivery network 62 to a player, such as for live streaming applications, or to a database 52 for video on demand applications. As described above, the apparatus of this example embodiment may be embodied by the video content source 42 and, in particular, by an MPD generator 50 in order to create a media presentation description including supplemental fields including information regarding the coordinates and span of each of a plurality of tiles of video content as well as segment information provided by the encoder, such as the cloud in this example embodiment. The resulting media presentation descriptions may be provided to the player and may be utilized by the player to identify the tile(s) that fill the user's field of view. Thus, the tile(s) associated with the field of view may be download along with the lower resolution base layer. The player may then present the higher resolution video content of the downloaded tiles within the field of view and the lower resolution base layer outside of the field of view, thereby supporting the delivery of high quality video content while conserving bandwidth.

As described above, FIGS. 2 and 3 illustrate flowcharts of an apparatus 10, method, and computer program product according to example embodiments of the invention. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory device 14 of an apparatus employing an embodiment of the present invention and executed by a processor 12 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, may be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
determining coordinates and span of each of a plurality of tiles of video content generated by an encoder;
creating a media presentation description including segment information and supplemental fields including information regarding the coordinates and span of the plurality of tiles of video content, wherein the media presentation description serves to identify one or more file segments comprising one or more tiles that are coextensive with a field of view; and
providing for view dependent delivery by associating the media presentation description with file segments to be delivered to a player.

2. A method according to claim 1 further comprising receiving an encoder-generated media presentation description, wherein creating the media presentation description comprises combining the segment information from the encoder-generated media presentation description with information regarding the coordinates and span of each of a plurality of tiles of video content.

3. A method according to claim 1 further comprising:
receiving an encoder-generated media presentation description; and
repeatedly refreshing the media presentation description so as to include information from the encoder-generated media presentation description.

4. A method according to claim 3 wherein the encoder-generated media presentation description includes information regarding a publish time and an availability start time, and wherein repeatedly refreshing the media presentation description comprises including information regarding the publish time and the availability start time.

5. A method according to claim 3 wherein the media presentation description is repeatedly refreshed in conjunction with live streaming of the video content.

6. A method according to claim 1 wherein the media presentation description is created a single time for a video on demand application.

7. An apparatus comprising at least one processor and at least one memory including computer program code, the at least one memory coupled to the at least one processor, and the computer program code configured to, when executed by the at least one processor, cause the apparatus to:
determine coordinates and span of each of a plurality of tiles of video content generated by an encoder;
create a media presentation description including segment information and supplemental fields including information regarding the coordinates and span of the plurality of tiles of video content, wherein the media presentation description serves to identify one or more file segments comprising one or more tiles that are coextensive with a field of view; and
provide for view dependent delivery by associating the media presentation description with file segments to be delivered to a player.

8. An apparatus according to claim 7 wherein the at least one memory and the computer program code are further configured to, when executed by the processor, cause the apparatus to receive an encoder-generated media presentation description, and wherein the at least one memory and the computer program code are configured to, when executed by the processor, cause the apparatus to create the media presentation description by combining the segment information from the encoder-generated media presentation description with information regarding the coordinates and span of each of a plurality of tiles of video content.

9. An apparatus according to claim 7 wherein the at least one memory and the computer program code are further configured to, when executed by the processor, cause the apparatus to:
receive an encoder-generated media presentation description; and
repeatedly refresh the media presentation description so as to include information from the encoder-generated media presentation description.

10. An apparatus according to claim 9 wherein the encoder-generated media presentation description includes information regarding a publish time and an availability start time, and wherein the at least one memory and the computer program code are configured to, when executed by the processor, cause the apparatus to repeatedly refresh the media presentation description by including information regarding the publish time and the availability start time.

11. An apparatus according to claim 9 wherein the media presentation description is repeatedly refreshed in conjunction with live streaming of the video content.

12. An apparatus according to claim 7 wherein the media presentation description is created a single time for a video on demand application.

13. An apparatus according to claim 7 wherein the apparatus is embodied by the encoder.

14. An apparatus according to claim 7 wherein the apparatus is embodied by a computing device in communication with but discrete from the encoder.

15. A computer program product comprising a non-transitory computer readable storage medium, the non-transitory computer readable storage medium comprising instructions that, when executed, are configured to cause:
determining coordinates and span of each of a plurality of tiles of video content generated by an encoder;
creating a media presentation description including segment information and supplemental fields including information regarding the coordinates and span of the plurality of tiles of video content, wherein the media presentation description serves to identify one or more file segments comprising one or more tiles that are coextensive with a field of view; and
providing for view dependent delivery by associating the media presentation description with file segments to be delivered to a player.

16. A computer program product according to claim 15 wherein the instructions, when executed, are further configured to receive an encoder-generated media presentation description, and wherein the instructions configured to create the media presentation description comprise instructions configured to combine the segment information from the encoder-generated media presentation description with information regarding the coordinates and span of each of a plurality of tiles of video content.

17. A computer program product according to claim 15 wherein the instructions, when executed, are further configured to:
receive an encoder-generated media presentation description; and
repeatedly refresh the media presentation description so as to include information from the encoder-generated media presentation description.

18. A computer program product according to claim 17 wherein the encoder-generated media presentation description includes information regarding a publish time and an availability start time, and wherein the instructions configured to repeatedly refresh the media presentation description comprise instructions configured to include information regarding the publish time and the availability start time.

19. A computer program product according to claim 17 wherein the media presentation description is repeatedly refreshed in conjunction with live streaming of the video content.

20. A computer program product according to claim 15 wherein the media presentation description is created a single time for a video on demand application.
